(19) United States
(12) Patent Application Publication
(10) Pub. No.: US 2012/0125793 A1
(43) Pub. Date: May 24, 2012

(54) Blade Storage Devices and Methods

(76) Inventor: Joe S. Benvenuto, El Dorado Hills, CA (US)

(21) Appl. No.: 13/293,646

(22) Filed: Nov. 10, 2011

Related U.S. Application Data
(60) Provisional application No. 61/415,236, filed on Nov. 18, 2010.

(51) Int. Cl. A45C 11/26; B23P 11/00

(52) U.S. Cl. 206/349; 29/428

(57) ABSTRACT

A device is provided for storing a blade. The device may include a casing and a lid. The casing and lid may cooperate to form a cavity. The lid may be pivotally connected to the casing so as to be movable between an open configuration and a closed configuration. The cavity may be configured to receive one or more blades when the lid is in the open configuration and to securely store the one or more blades in the cavity when the lid is in the closed configuration. The stored blades may be at least partially submerged in a fluid positioned in the cavity when the lid is in the closed configuration. A seal may be formed between the casing and the lid such that the cavity is sealed when the lid is in the closed configuration.

### CROSS-REFERENCE TO RELATED APPLICATIONS

The present application claims the priority benefit of U.S. Provisional Application No. 61/415,236, filed Nov. 18, 2010, entitled “Universal Casing for Blade”, which is hereby incorporated by reference herein in its entirety.

### FIELD OF THE INVENTION

The present disclosure generally relates to blades, and more particularly, to storage devices for shaving razor blades.

### BACKGROUND

It is well known in the art that blades (e.g., shaving razor blades) dull over time. This is due, in part, to oxidation of the portion of the blade having the cutting surface. This oxidation is caused by a variety of factors. In the case of a shaving razor blade, a critical component of oxidation includes exposure of the cutting surface to water or other sources of moisture associated with ordinary use. Storage devices have previously been proposed to slow or minimalize the oxidation by storing the blade in oils, liquids, and the like. However, these devices have generally been cost prohibitive due to overly complicated construction and/or designs. This also results in storage devices that are too complicated to use effectively which often ultimately results in dulling of the blade.

For example, a number of prior art storage devices do not reliably protect the blade due to overly stringent usage requirements. In some embodiments, the earlier storage devices require a constant vertical orientation of the device so as to prevent spillage of the fluid stored inside. This prevents the user from easily traveling with the storage device. Other embodiments also provided for storage of the blade in fluids (e.g., mineral oil) having a viscosity that permits the fluid to readily spill or leak from the device. Some embodiments even require the user to mix the storage fluids in a storage chamber prior to inserting the blade. These, as well as other features generally result in storage devices that are complicated, expensive, and that do not reliably protect the blade being stored therein. There is, therefore, a need for devices and methods for storing blades which eliminates these and other problems with existing systems.

### SUMMARY OF THE INVENTION

According to various embodiments, a device is provided for storing a blade. The device may include a casing and a lid. The casing and lid may cooperate to form a cavity. The lid may be pivotally connected to the casing so as to be movable between an open configuration and a closed configuration. The cavity may be configured to receive one or more blades when the lid is in the open configuration and to securely store the one or more blades in the cavity when the lid is in the closed configuration. The stored blades may be at least partially submerged in a fluid or wax received in the cavity when the lid is in the closed configuration.

A seal may be formed between the casing and the lid such that the cavity is sealed when the lid is in the closed configuration. The casing may be formed using a rigid material. The fluid may be carnauba wax. The device may further include a flexible neck including an opening. The flexible neck may be coupled to the casing such that the flexible neck receives at least a portion of the blade. The device may further include a fastener encircling the flexible neck, the fastener being configured to adjust the size of the opening. The device may further include a securing device configured to seal the opening, and the securing device may be formed using a pliable material.

The casing may include a base portion and an upper portion. In various aspects, the lid may be pivotally attached to the upper portion. The device may further include an elastic bladder positioned inside the cavity and containing the wax. A seal may be formed via a sealing device positioned between the casing and the lid.

According to some embodiments, a method is provided for storing a blade. The method may include the step of forming a rigid casing and the step of applying a lid to the casing to thereby form a cavity, the casing and lid being configured to receive a blade when the lid is in an open configuration and to store the blade in the cavity when the lid is in a closed configuration, the stored blade being at least partially submerged in a fluid stored in the cavity when the lid is in the closed configuration. The method may also provide for forming flexible neck coupled to the rigid casing, the flexible neck including an opening configured to receive at least a portion of the blade. The method may include forming a securing device configured to seal the opening when the blade is stored in the cavity. The securing device may be formed using a pliable material. The method may provide for pivotally or hingedly attaching the lid to the casing. The wax may be carnauba wax.

According to even further embodiments, a method is provided for forming a storage device for a blade. The method may provide for forming a casing; attaching a lid to the casing, the lid and casing cooperating to define a cavity, the cavity configured to receive a blade when the lid is in an open configuration and to securely store the blade when the lid is in a closed configuration; and inserting a fluid into the cavity, the stored blade being at least partially submerged in the fluid. The fluid may be carnauba wax. The method may also provide for coupling a neck having an opening to the casing, wherein the opening is formed of a pliable material.

### BRIEF DESCRIPTION OF THE DRAWINGS

FIG. 1 is a perspective view showing an exemplary device constructed in accordance with aspects of the present disclosure.

FIGS. 2A-D show various embodiments of the opening.

FIG. 3 is a top plan view showing an embodiment including a neck, in accordance with aspects of the present disclosure.

FIG. 4 is a perspective view showing another embodiment of a device constructed in accordance with aspects of the present disclosure.

FIG. 5 is a perspective view showing more particular features of the embodiment shown in FIG. 4.

FIGS. 6A-E show further views of the embodiment shown in FIG. 4.

FIG. 7 is a flow diagram showing a method of forming a storage device for a blade.

FIG. 8 is a flow diagram showing another method of forming a storage device for a blade.

### DETAILED DESCRIPTION OF THE INVENTION

The present disclosure is not intended to be limited in its application to the details of construction and the arrangement of the components set forth in the following description or illustrated in the drawings. The present disclosure is capable of other embodiments or of being practiced or carried out in various ways. As such, the language used herein is intended to be given the broadest possible scope and meaning; and the embodiments are meant to be exemplary—not exhaustive. It is to be understood that the phraseology and terminology employed herein is for the purpose of description and should not be regarded as limiting. Unless otherwise required by context, singular terms may include pluralities and plural terms may include the singular.

It is to be understood that the term “blade” or “blades” as used herein may refer to a variety of devices or components having cutting blades. Exemplary blades include, but are not limited to a shaving razor blade, a kitchen knife blade, a box cutter, a chisel, or any other cutting tool.

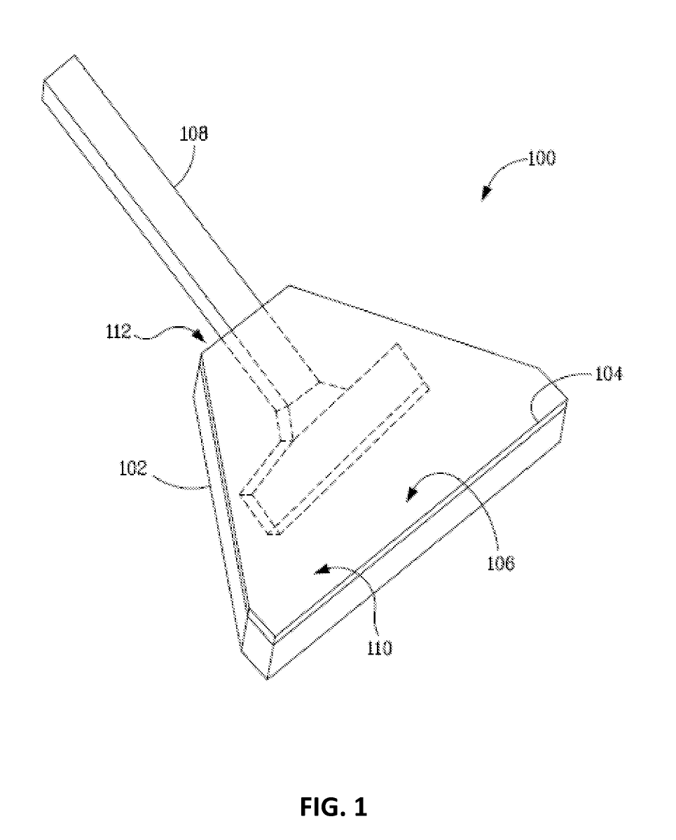

FIG. 1 shows a perspective view of an exemplary device 100 for storing a blade, in accordance with the present disclosure. The device 100 may comprise a casing 102 and a lid 104. The casing 102 and the lid 104 may cooperate to define a cavity 106. The cavity 106 may receive one or more blades 108 (one being shown in FIG. 1 by way of example). The cavity 106 may receive the blade 108 when the lid 104 is in an open configuration (now shown in FIG. 1) and store the blade 108 when the lid 104 is in a closed configuration. A fluid 110 may be provided in the cavity 106. The blade 108 stored in the cavity 106 may be submerged or at least partially submerged in the fluid 110 when the lid 104 is in the closed configuration. In various embodiments, the fluid 110 may be a wax, such as carnauba wax. For ease of description, the fluid may be referred to herein as a wax.

The device 100 can be formed using a variety of shapes and/or sizes depending on an intended application. That is, the device 100 may be utilized to store a plurality of blades 108 and also blades 108 having different sizes and/or shapes. The casing 102 and the lid 104 may be correspondingly sized and/or shaped so as to form or otherwise define the cavity 106 such that the cavity 106 can receive and store the blade 108. Further, as discussed in more detail below, the casing 102 and lid 104 may be similarly sized and/or shaped such that the cavity 106 can be sealed. In certain embodiments, the casing 102 and lid 104 are sized and/or shaped so as to substantially conform to the size and/or shape of the blade 108 to be stored therein.

The lid 104 may be composed of the same materials as the casing 102, or may be composed of different materials, depending upon user preference. The casing 102 and/or the lid 104 may be formed using a rigid material or a semi-rigid material. Some embodiments may provide for forming the casing 102 and/or lid 104 using a transparent material, an opaque material, or combinations thereof. In some embodiments, the casing 102 and the lid 104 may be formed of a rigid material so that, should the blade 108 come into contact with the casing 102 or the lid 108, the blade 108 will not cut or otherwise damage the casing 102 and/or the lid 104. Exemplary materials may include glass, plastic, composite, metal, elastomeric materials, etc., or combinations thereof. Further, some aspects may provide for the casing 102 to be formed as a unitary piece.

The casing 102 may be formed as two or more pieces reversibly connected (e.g., a base portion and an upper portion), or the casing 102 may be formed of two components connected either removably or permanently. Some embodiments may provide for the wax 110 to be provided in a bladder (not shown) positioned in the cavity 106. In such embodiments, the casing 102 may be formed of two components removably connected such that the bladder containing the wax 110 can be removed and replaced. The casing 102 to be formed of two pieces permanently connected using, for example, sonic welding. The wax 110 can be placed in the cavity 106 before the two pieces forming the casing 102 are connected.

A seal (not shown in FIG. 1) may be formed or otherwise provided between the casing 102 and the lid 104 when the lid 104 is in the closed configuration. In certain embodiments, the casing 102 may include one or more raised ridges wherein the lid 104 may include corresponding recesses accepting the ridges. The ridges and recesses may extend around the contacting surfaces of the casing 102 and lid 104. Other embodiments may provide for the raised ridges to be included on the lid 104 wherein the matching recesses are included in the casing 102. The one or more raised ridges and recesses may cooperate to form a mating relationship so as to form the seal when the lid 104 is in the closed configuration. Other aspects may provide for the seal to be provided in the form of a material positioned between the casing 102 and the lid 104. Exemplary materials may include rubber, plastic, composite, gasket, washer, etc. Generally, the seal may provide for retention of the wax 110, or otherwise prevent the wax 110 from leaking or spilling out of the cavity 106 when the lid 104 is in the closed configuration.

The device 100 may be configured such that the lid 104 can be movable between an open configuration and a closed configuration. In a preferred embodiment, the lid 104 can be pivotally (e.g., hingedly) attached or otherwise connected to the casing 102 wherein the lid 104 can thereby be moved from the open configuration to the closed configuration, and vice versa. Other embodiments may provide for the lid 104 to be removable from, and replaceable on, the casing 102. For instance, the casing 102 and/or lid 104 may include one or more clips, compression fittings, and the like, which permit a user to remove the lid 104 from the casing 102, place the blade 108 into the cavity 106, and secure the lid 104 to the casing 102. Such clips, compression fittings, and the like are known in the art.

The cavity 106 may be formed in the casing 102 and/or defined by the cooperation between the casing 102 and the lid 104. The cavity 106 may be of sufficient diameter, depth, size, shape, etc. to allow a cutting surface of each of the one or more blades 108 to be submerged in the wax 110. The wax 110 may reduce exposure of the one or more blades 108 to dirt, water, and moisture contained in air when the one or more blades 108 are contained in the storage device 100. In an exemplary embodiment, the wax 110 may include carnauba wax, or a number of other suitable waxes. The wax 110 may have any suitable viscosity sufficient to reduce contact of the one or more blades 108 with air or other environmental contaminants. In a preferred embodiment, the wax 110 may be an environmentally-friendly substance, such as carnauba wax.

After the one or more blades 108 are used by the user (e.g., for cutting applications), the one or more blades 108 may be cleaned, dried and inserted into the cavity 106. The lid 104 may then be engaged with the casing 102 (using for example one or more clips, a hinge, or other securing devices) to seal the one or more blades 108 and the wax 110 within the cavity 106. In some embodiments, the lid 104 may be engaged with the casing 102 using an indexed hinge. The indexed hinge may include grooves within it that allow the lid 104 to lock in an adjustable position without the need of other fasteners. When stored in the storing device 100 in such a manner, the useful life of the one or more blades 108 may be extended due to the reduction of exposure to contaminants such as dirt, fluids, or moisture.

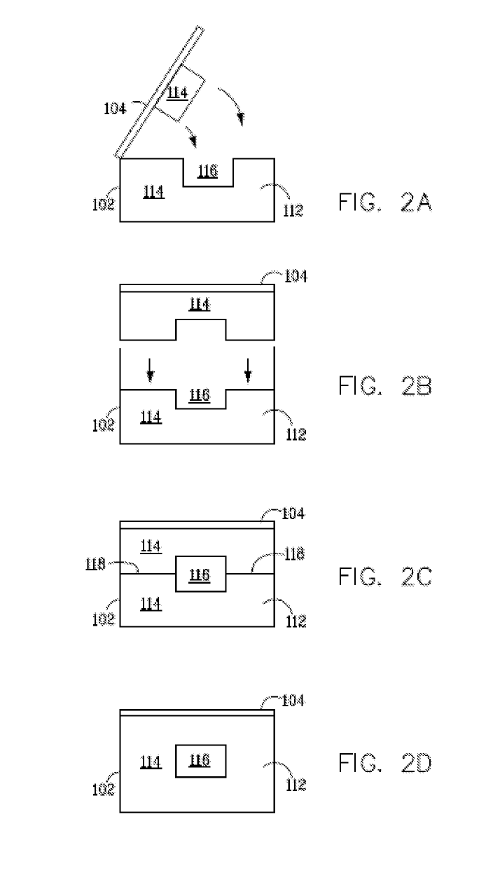

The device 100 may further comprise an opening 112. The opening 112 may be configured to permit at least a portion of the blade 108 to be positioned in the device 100 and to thereby form a seal around the portion of the blade protruding therefrom to thereby prevent the wax 110 from leaking or otherwise escaping from the cavity 106. The opening 112 as well as the seal between the casing 102 and the lid 104 may also cooperate to prevent water or any other liquids/fluids from entering the device 100 when the blades 108 are stored therein. FIG. 2 provides exemplary openings 112 according to various embodiments of the present disclosure. Generally, the opening 112 may include a sealing material 114 positioned within at least a portion of the opening 112. The sealing material 114 may be formed as one piece or as two pieces wherein the two pieces cooperate to form the sealing material 114. When formed as two pieces, a first piece of the sealing material 114 may be connected to the casing 102 and a second piece of the sealing material 114 may be connected to the lid 104. The material 114 may further define a receiving portion 116. When the sealing material 114 is formed of two pieces, the receiving portion 116 may be opened or otherwise made available when the lid 108 is in the open configuration. The receiving portion 116 may be sized and/or shaped so as to provide a seal around the portion of the blade 108 protruding from the device 100 when the lid is in the closed configuration. In a preferred embodiment, the sealing material 114 is formed of a pliable material such that the material 114 can form the seal around the protruding portion of the blade 108 when the lid 104 is in the closed configuration. An exemplary material used to form the sealing material 114 includes rubber.

As shown in FIG. 2A, the lid 104 is pivotally (e.g., hingedly) attached to the casing 102 and is in the open configuration. The blade 108 can be positioned in the cavity 106 when the lid 104 is in the open configuration with any protruding portion of the blade 108 positioned in the receiving portion 116. When the lid 104 is moved to the closed configuration, the sealing material 114 forms a seal around the protruding portion of the blade 108 As shown in FIG. 2B, the lid 104 may be removable from the casing (e.g., when the blade 108 is removable from, and replaceable in, the casing 102). In the open configuration shown in FIG. 2B, the blade 108 may be placed or received in the cavity 106. When the lid 104 is lowered onto the casing 102 (i.e., moved to the closed configuration), the sealing material 114 forms the seal around the protruding portion of the blade 108.

As illustrated in FIG. 2C, various embodiments may provide for the sealing material 114 to be formed as a single piece of material that has a flexibility sufficient to permit the blade 108 to be inserted into, and removed from, the cavity 106 through the opening 112. In other words, the sealing material 114 may stretch or otherwise conform sufficiently to permit a portion of the blade 108 to be pushed through the receiving portion 116 and yet to maintain a seal around any portion of the blade 108 protruding from the receiving portion 116. Other embodiments may provide for the sealing material 114 to include one or more slits 118 therein. The one or more slits 118 are configured to permit the blade 108 to be inserted through the opening 112 and into the cavity 106 and to then form the seal around the protruding portion of the blade 108 using the sealing material 114. The opening 112 and the sealing material 114 having the one or more slits 118 may be sized and/or shaped to correspond to the size and/or shape of the blade 108. In this embodiment, the blade 108 may be inserted into the cavity 106 without moving the lid 104 to the open configuration. As shown in FIG. 2D, the opening 112 including the sealing material 114 provides the seal around any protruding portion of the blade 108.

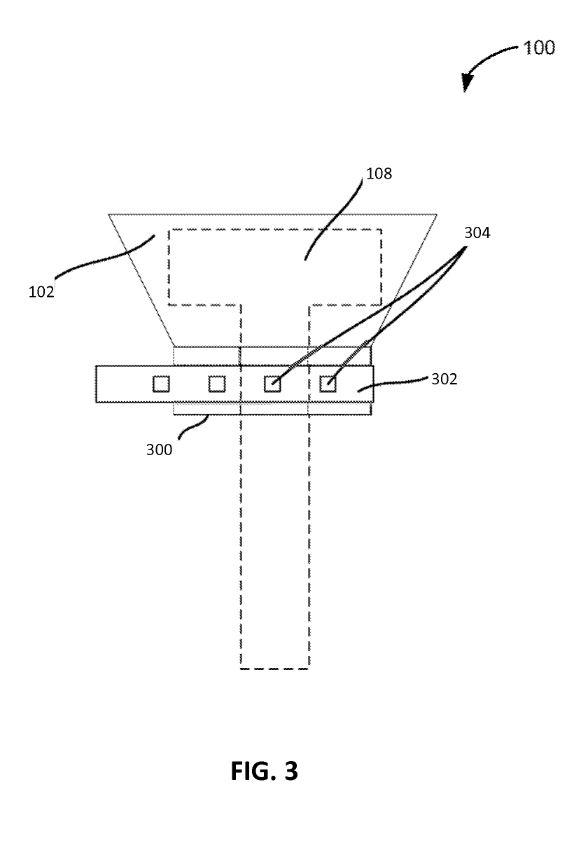

FIG. 3 shows a device 100 further comprising a neck 300. The neck 300 may be formed of a flexible material and may further be coupled to the casing 102 such that the flexible neck 300 receives at least a portion of the blade 108 (e.g., the portion protruding). The flexible neck 300 may further include a fastener 302 and one or more clips 304. The blades 108 may be positioned in the cavity 106 within the casing 102. The blade 108 may be any blade, such as a razor blade, kitchen knife blade, or other cutting tool. The casing 102 may be rigid, and may have sufficient hardness so that the blade 108 will not damage the casing 102 should the blade 108 come into contact with an inside surface of the casing 102. The casing 102 may be composed of any suitable material, such as, for example, plastic, metal, or wood.

The neck 300 may assist in holding the one or more blades 108 in place. The neck 300 may be flexible, and may include the opening 112. Any suitable material and/or combination of materials may be used for the neck 300, such as rubber, plastic, or cloth, for example. The neck 300 may be coupled to the casing 102 such that the one or more blades 108 may enter the casing 102 via insertion through the opening 112.

The fastener 302 may encircle the neck 300, and may be used to fix the size and/or shape of the opening 112 so that the cavity 106 may be sealed. The fastener 302 may use any suitable mechanism to fix the opening 112 at a particular size and/or shape. In an exemplary embodiment, the one or more clips 304 may be used to permit the opening 112 to be fixed at a plurality of different sizes and/or shapes. However, the present technology is not limited in this regard, and other embodiments of the fastener 302 may be used, such as, for example, a draw string or rope, a clamp, or a series of buttons or snaps. When the opening 112 is fixed at a particular size and/or shape by the fastener 302, the neck 300 may be allowed to change shape, but may maintain substantially the same perimeter or circumference in some embodiments.

The fastener 302 may be configured to adjust the size of the opening 112 to allow one or more blades 108 to be inserted and removed from the cavity 106 as desired. When a user wishes to seal the cavity 106 and store the one or more blades 108 therein, the fastener 302 may further be used to hold an end of the one or more blades 108 in place. For example, it may be desirable to loosen the fastener 302 to make the opening 112 larger to accommodate inserting and removing a larger blade 108.

As discussed above, the size of the opening 112 in the neck 300 may be adjusted and fixed using the fastener 302 and the clips 304. As also discussed above, the opening 112 may be lined with flexible material (e.g., the sealing material 114), such as rubber, to more securely seal the opening 112.

In certain embodiments, the device 100 may not include the fastener 302 and the clips 304. As discussed above, the lid 104 may be engaged with the casing 102 using an indexed hinge. The indexed hinge may include grooves within it that allow for the lid 104 to lock into place without the need of other fasteners. The opening 112 may be configured in such embodiments to secure the portion of the blade 108 protruding therefrom when the lid 104 is locked into place (i.e., in the closed configuration).

It may be desirable to decrease the likelihood of the wax 110 leaking as the storage device 100 is exposed to wear over time. This may be accomplished by coupling, in an exemplary embodiment, the neck 300 to an elastic bladder (not shown in FIG. 3) that is located inside the cavity 106 and contains the wax 110 and the one or more blades 108. Such an embodiment may have an additional advantage of facilitating the changing of the wax 110 when, for example, the wax 110 becomes dirty over time.

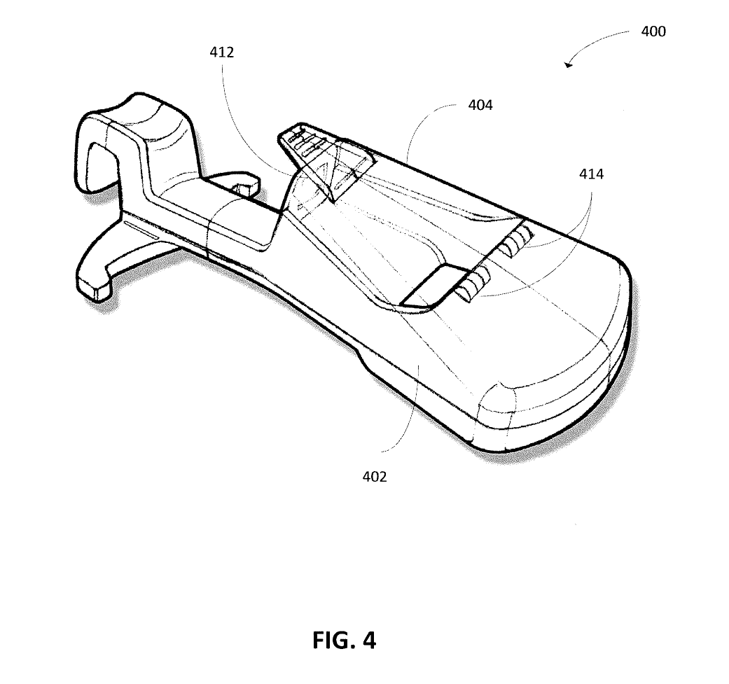

FIG. 4 is a perspective view of another embodiment of a storage device 400 for a blade. Similar to the device 100 discussed above, the device 400 comprises a casing 402, a lid 404, and an opening 412. The device 400 shown in FIG. 4 may be utilized to store a blade (not shown) wherein at least a portion of the blade is submerged in a wax positioned in a cavity. In the embodiment shown in FIG. 4, the lid 404 is pivotally attached or connected to the casing 402 via hinges 414. The hinges 414 permit the lid 404 to be moved between the open configuration wherein the blade (e.g., blade 108) can be received into the cavity and the closed configuration wherein the blade is securely stored in the cavity. The hinges 414 may be indexed hinges. When the blade is stored in the cavity, at least a portion of the blade may be submerged in the wax stored therein. The opening 412 may be similar to the opening 112 discussed above and may include a sealable material operating to form a seal around any portion of the blade extending therefrom.

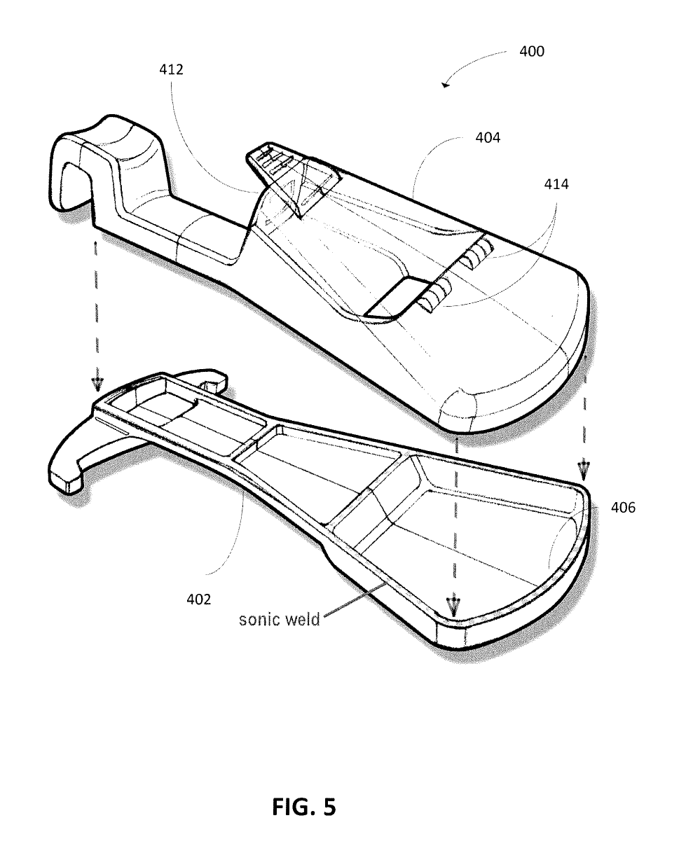

FIG. 5 is a broken perspective view of the embodiment shown in FIG. 4. As discussed above regarding casing 102, the casing 402 may be formed using a two-piece construction. FIG. 5 illustrates a particular example of such a configuration wherein the casing 402 is formed using a base portion and an upper portion that are connected via, for example, a sonic weld around at least a portion of the mating surfaces. FIG. 5 also more clearly shows the cavity 406 formed between the casing 402 and the lid 404. The device 400 is configured such that a blade stored therein is at least partially submerged in the wax stored in the cavity 406.

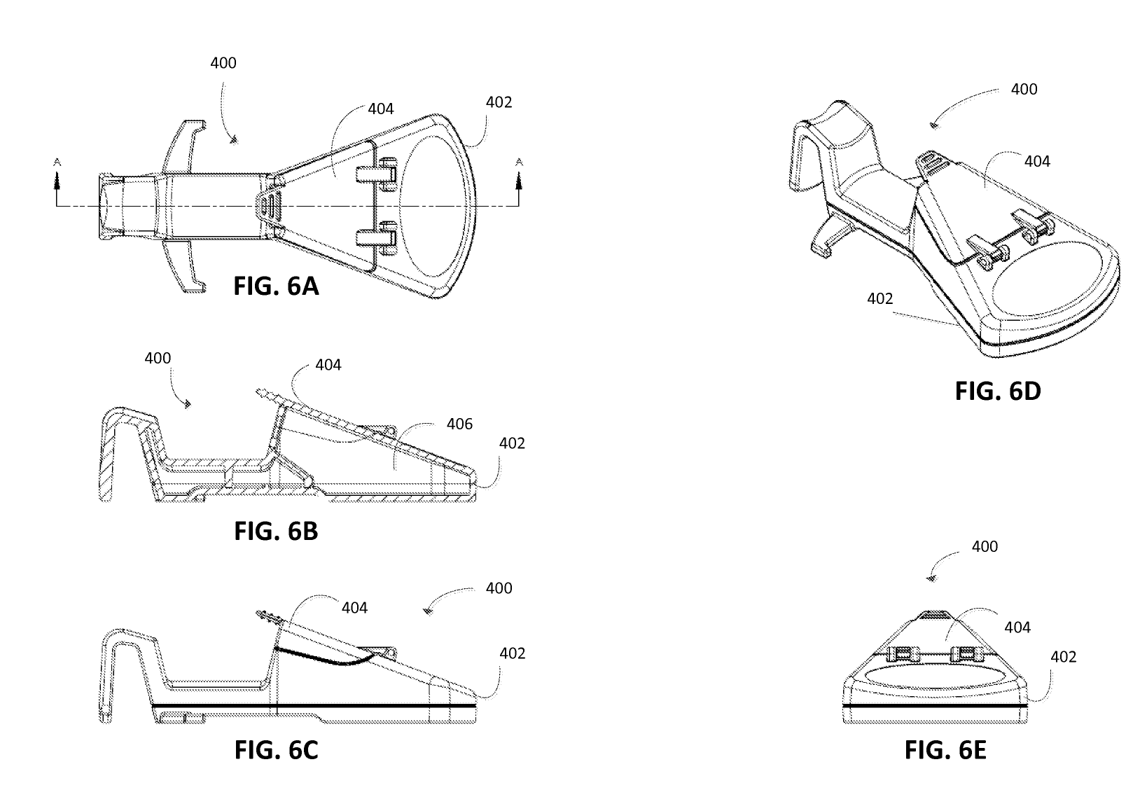

FIGS. 6A-E show further views of the embodiment shown in FIG. 4. In particular, FIG. 6A is a top plan view of the device 400. FIG. 6B is a cut away side plan view of the device 400 taken along the cut-line A-A shown in FIG. 6A. FIG. 6C is a side plan view of the device 400. FIG. 6D is a perspective view of the device 400. FIG. 6E is a front plan view of the device 400. As discussed above, the device 400 may include the casing 402, the lid 404, with the casing 402 and lid 404 forming the cavity 406. The device 400 may also include the upper portion and base portion, as also discussed above with respect to FIG. 5.

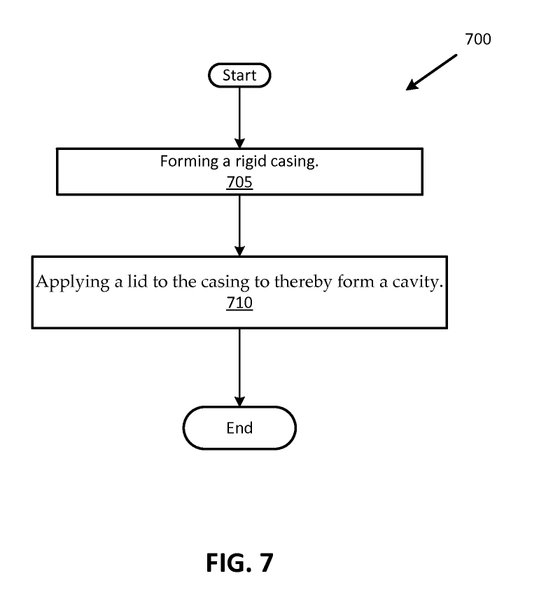

FIG. 7 is a flow diagram showing a method 700 of forming a storage device for a blade. The method 700 may include the step 705 of forming a rigid casing. The rigid casing (e.g., the casing 102 discussed herein) may be formed as a one-piece construction or as a two-piece construction (e.g., a base portion and an upper portion) wherein the two pieces are sonic welded together.

The method 700 may also include the step 710 of applying a lid to the casing to form a cavity. The casing and lid may be configured to receive a blade when the lid is in an open configuration and to store the blade in the cavity when the lid is in a closed configuration. The stored blade may be at least partially submerged in a fluid stored in the cavity when the lid is in the closed configuration. The lid (e.g., lid 104 or 404) may be pivotally coupled to the casing. The fluid may be stored in the cavity using a bladder positioned in the cavity. The fluid may be a wax, such as carnauba wax.

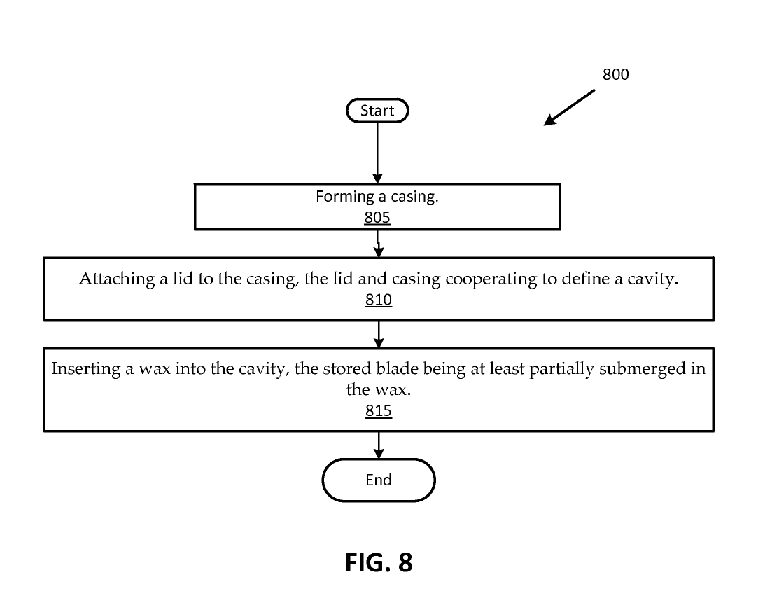

FIG. 8 is a flow diagram showing a method 800 of forming a storage device for a blade. The method 800 may include the step 805 of forming a casing. The casing may be similar to the casing 102 and/or 402 discussed above. The casing may be formed of a rigid material. Various aspects may provide for a casing constructed using a two-piece construction.

The method 800 may further include the step 810 of attaching a lid to the casing, the lid and casing cooperating to define a cavity. The cavity may be configured to receive a blade when the lid is in an open configuration and to securely store the blade when the lid is in a closed configuration. The lid may be pivotally attached to the casing. Various embodiments may provide for the lid to be attached to the casing using one or more hinges, e.g., indexed hinges. The cavity may be sized and/or shaped so as to receive and store the blade.

The method 800 may further include the step 815 of inserting a fluid into the cavity, the stored blade being at least partially submerged in the fluid. The fluid may be a wax, such as carnauba wax.

While the present invention has been described in connection with a series of preferred embodiments, these descriptions are not intended to limit the scope of the invention to the particular forms set forth herein. The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. The present descriptions are intended to cover such alternatives, modifications, and equivalents as may be included within the spirit and scope of the invention as defined by the appended claims and otherwise appreciated by one of ordinary skill in the art. In several respects, embodiments of the present invention may act to close the loopholes in the current industry practices in which good business practices and logic are lacking because it is not feasible to implement with current resources and tools.

What is claimed is:

1. A device comprising:
a casing;
a lid, the casing and lid cooperating to form a cavity that receives one or more blades when the lid is in an open configuration and to securely store the one or more blades in the cavity when the lid is in a closed configuration, the stored blades being at least partially submerged in a fluid positioned in the cavity when the lid is in the closed configuration; and
a seal formed between the casing and the lid such that the cavity is sealed when the lid is in the closed configuration.

2. The device of claim 1, further comprising a flexible neck including an opening, wherein the flexible neck is coupled to the casing such that the flexible neck receives at least a portion of the blade.

3. The device of claim 2, further comprising a fastener encircling the flexible neck, the fastener being configured to adjust the size of the opening.

4. The device of claim 2, further comprising a securing device configured to seal the opening.

5. The device of claim 4, wherein the securing device is formed using a pliable material.

6. The device of claim 1, wherein the casing is formed using a rigid material.

7. The device of claim 1, wherein the fluid is carnauba wax.

8. The device of claim 1, wherein the casing comprises a base portion and an upper portion, the lid being pivotally attached to the upper portion.

9. The device of claim 1, further comprising an elastic bladder positioned inside the cavity and containing the fluid.

10. The device of claim 1, wherein the lid is pivotally attached to the casing.

11. The device of claim 1, wherein the seal is formed via a sealing device positioned between the casing and the lid.

12. A method of forming a storage device for a blade, the method comprising:
forming a rigid casing;
applying a lid to the casing to thereby form a cavity, the casing and lid being configured to receive a blade when the lid is in an open configuration and to store the blade in the cavity when the lid is in a closed configuration, the stored blade being at least partially submerged in a fluid stored in the cavity when the lid is in the closed configuration.

13. The method of claim 12, further comprising the step of forming flexible neck coupled to the rigid casing, the flexible neck including an opening configured to receive at least a portion of the blade.

14. The method of claim 13, further comprising the step of forming a securing device configured to seal the opening when the blade is stored in the cavity.

15. The method of claim 14, wherein the securing device is formed using a pliable material.

16. The method of claim 12, wherein applying the lid further includes hingedly attaching the lid to the casing.

17. The method of claim 12, wherein the fluid is carnauba wax.

18. A method of forming a storage device for a blade, the method comprising:
forming a casing;
attaching a lid to the casing, the lid and casing cooperating to define a cavity, the cavity configured to receive a blade when the lid is in an open configuration and to securely store the blade when the lid is in a closed configuration; and
inserting a fluid into the cavity, the stored blade being at least partially submerged in the fluid.

19. The method of claim 18, wherein the fluid is carnauba wax.

20. The method of claim 18, further comprising the step of coupling a neck having an opening to the casing, wherein the opening is formed of a pliable material.
